(19) United States
(12) Patent Application Publication
(10) Pub. No.: US 2010/0146881 A1
(43) Pub. Date: Jun. 17, 2010

(54) HURRICANE WINDOW COVER

(75) Inventors: Benn Leonard Framer, Midvale, UT (US); Grant Turpin, Magna, UT (US); Danny Turpin, South Jordon, UT (US)

Correspondence Address: THORPE NORTH & WESTERN, LLP., P.O. Box 1219, SANDY, UT, 84091-1219, US

(73) Assignee: GDT Holdings, LLC, Magna, UT (US)

(21) Appl. No.: 12/626,087

(22) Filed: Nov. 25, 2009

Related U.S. Application Data
(63) Continuation-in-part of application No. 11/534,584, filed on Sep. 22, 2006, now abandoned.
(60) Provisional application No. 60/719,731, filed on Sep. 22, 2005.

(51) Int. Cl. E06B 9/00

(52) U.S. Cl. 52/202

(57) ABSTRACT

A protective cover for windows and doors is formed of a resilient and flexible material such as rubber, for example, a rubber material made from recycled tires. The cover may be rolled up to form a cylinder for storage when not needed and then unrolled when needed to cover the window or door. A kit contains a pre-sized protective cover and means for securing the cover to a building. When needed, the cover is attached to a cover frame which holds the perimeter of the cover around the window or door to be protected, and support is provided, such as by straps extending across the cover frame, between the cover and the window or door to be protected to limit the stretching of the material.

### PRIORITY CLAIM

This application is a continuation-in-part of U.S. patent application Ser. No. 11/534,584, entitled “Hurricane Window Cover”, filed on Sep. 22, 2006, which claims priority to U.S. Provisional Application Ser. No. 60/719,731, entitled “Hurricane Window Cover”, filed Sep. 22, 2005, both of which are hereby incorporated by reference.

### FIELD OF THE INVENTION

The present invention is directed to the field of protective coverings for windows and doors during severe storms, such as hurricanes.

### BACKGROUND OF THE INVENTION

During severe storms, such as hurricanes, most of the damage to a building results from wind or wind-borne missiles that break windows and allow rain and wind into the building. Once the wind is inside a building, the resulting pressure can even lift the roof off of the building. Temporary coverings are often placed over windows to reduce or prevent damage to the building during a hurricane.

During hurricane warnings, homeowners often nail plywood over windows and glass doors to prevent wind-driven rain and debris from breaking the windows and entering the house. Although plywood is an inexpensive material, it is difficult to nail to a home quickly. Nailing sheets of plywood to a home is time-consuming and cumbersome due to the weight of the material, and the need for assistance. Homeowners are often reluctant to drive nails into their window frames or do not want to be on a ladder during high winds. In addition, usually more than one person is needed as individuals cannot hold up a large, heavy piece of plywood and nail it in at the same time. Further, strong winds often rip nailed plywood off of a window frame, and rain and winds warp the plywood so that it cannot be reused after a storm.

A number of protective coverings have been designed. U.S. Pat. No. 6,205,713 to Thompson et al. describes a shutter system which includes brackets above or below a window and sliding latches at the edges of the window. U.S. Pat. No. 6,131,354 to Thompson and U.S. Pat. No. 6,532,702 to Scribner show mounting systems for mounting a protective covering over a window or door. Transparent shutter systems are described in U.S. Pat. No. 4,685,261 to Seaquist and U.S. Pat. No. 5,228,238 to Fenkell. An accordion fold shutter system is described in U.S. Pat. No. 5,522,445 to Hoffman.

However, there remains a need for a cost-effective, easy-to-use protective covering for windows and glass doors that is highly resistant to impact breakage, especially during the bombardment of debris or other air-borne projectiles during severe storms, such as hurricanes.

### BRIEF SUMMARY OF THE INVENTION

According to the invention, a resilient material, such as a sheet of rubber material, may be used as an effective protective storm covering for windows and doors when mounted over the windows and doors in a manner to support the material between its mounting and the window or door to be protected to limit the stretching of the material and prevent its contact with the window or door in the event of impact against the cover. During a severe storm, such as a hurricane, much damage is done by the impact of wind-borne objects that strike a building, particularly if the object strikes and breaks a window or door which allows wind and water into the building. Traditional window and door storm coverings, such as sheets of plywood or sheets of a metal material placed over the window or door, can be effective in stopping a wind-borne object, but such wind-borne object can cause damage to the covering material which prevents its reuse. For example, a wind-borne article, such as a piece of wood, can break a sheet of rigid protective material such as a sheet of plywood or a sheet of steel, upon impact with the rigid protective material because the rigid protective material does not absorb any of the impact. However, materials that that can absorb impact so as to not be damaged, are generally resilient and stretch to some degree to absorb the impact. When such impact absorbing materials are used, however, the stretch in the materials during impact will stretch the materials to an extent to break the window or door. While such protective material covering the window or door can prevent the wind and water from entering through the window or door, the broken window or door is storm damage that should be avoided.

It has been found that rubber mat materials, such as rubber mat material made from recycled tires, is strong enough to absorb great impacts without tearing or puncturing, but that such materials stretch to an extent that makes it difficult to use such materials to protect windows and doors with current systems of mounting protective window and door covers. The invention creates a mounting system which provides support for the cover between the cover and the window or door being protected to limit the stretch of such material toward the window or door. In one embodiment of the invention, a frame is provided around the window or door to be protected to secure the perimeter of the protective cover. The frame has an open area for the window or door and can be permanently installed to the structure around the window or door. Attachments for straps are provided in conjunction with the frame adapted to secure the straps across the frame and open area in the frame to divide the open area into a plurality of smaller open areas. The straps have limited stretch so limit the stretch of the cover material toward the window or door when the material is against the strap. This has also been found to limit the stretch of the material in the smaller open areas between the straps to the extent necessary to protect the window or door from the cover material. The number of straps necessary and the size of the smaller open areas will depend on the size of the frame opening and the cover material being used. It has been found that dividing the open area of the frame into smaller open areas of about two feet by two feet is sufficient to prevent window and door contact by the cover material when using a rubber mat material made from recycled tires and when the cover is secured greater than about two and one half inches from the window or door.

In one embodiment of the invention, the frame is constructed of lengths of F track cut to length and secured to the window frame or door frame or to other structure around the window or door so as to form a rectangular frame around the window or door to be protected. The frame has an open area for the window or door. The frame pieces are secured to the window frame or structure around the window or the door frame or structure around the door by connectors such as screws or bolts. The frame will generally be permanently attached to the structure. The bolts, or selected ones of the bolts or other connectors, are adapted to secure ends of straps which straps are secured across the frame when a storm is approaching. The straps divide the open area in the frame into smaller open areas in front of the doors or windows to be protected. F track includes a track to slidably receive the heads of bolts therein so that bolts will be held in the track with the threaded portion extending therefrom in the manner of studs and the bolts can be moved along the track to desired positioned and can be removed from the track when storm protection is not needed. The studs extending from the F track are slid into positions to extend through holes in the cover material and through holes in perimeter bars that are placed to sandwich the perimeter of the cover between the frame and a plurality of perimeter bars. Wing nuts tighten the perimeter bars against the cover and the frame. The cover is positioned outside of the straps when a storm is approaching. By outside the straps, it is meant that the straps are positioned between the cover and the window or door to be protected.

Depending upon the construction of the structure and the windows or doors, it may be necessary to build out around the window or door to provide sufficient distance between the cover and the window glass or the cover and the door. It is usually necessary to provide at least about two and one half inches between the cover and the window glass or the door to ensure that contact of the cover with the window or door will not occur in the event of severe impact of an object with the cover.

By using a resilient and flexible protective cover, the protective cover can be rolled up to form a cylinder for storage between uses and then unrolled to cover the window or door when a storm approaches and protection is needed. Parts for the storm protection system of the invention can be provided in the form of a kit containing a pre-sized protective cover and the components necessary to build the frame for the cover around the door or window to be protected and to attach the straps and cover to the frame when needed. Thus the kit, in addition to the presized protective cover, will include framing material, such as precut lengths of F track material or other framing material, to be secured to the structure around the window or door to be protected, bolts or other fasteners, and straps. Materials for constructing a buildout frame can also be included.

### BRIEF DESCRIPTION OF THE DRAWINGS

Additional features and advantages of the invention will be apparent from the detailed description which follows, taken in conjunction with the accompanying drawings, which together illustrate, by way of example, features of the invention; and, wherein:

FIG. 1 is an front elevation of a protective cover of the invention with a plurality of sets of mounting holes therethrough;

FIG. 2 is a front elevation of an installation of the protective cover of FIG. 1 according to an embodiment of the invention;

FIG. 3 is an exploded assembly view of the installation of FIG. 2;

FIG. 4 is a front elevation of an installation of a protective cover half the size of the protective cover shown in FIGS. 1, 2, and 3;

FIG. 5 is a vertical section showing the mounting of a cover frame to a wood window frame surrounding a window to be protected;

FIG. 6 is a vertical section showing the mounting of a cover frame to a block wall surrounding a window to be protected;

FIG. 7 is a vertical section showing the mounting of a cover frame to a wood window frame surrounding a window to be protected where a build out around the window to be protected is required; and

FIG. 8 is a fragmentary perspective exploded assembly view showing a corner of the installation of FIGS. 2 and 3 indicated by the enclosed area inside the line indicated as 8-8 in FIGS. 2 and 3.

Reference will now be made to the exemplary embodiments illustrated, and specific language will be used herein to describe the same. It will nevertheless be understood that no limitation of the scope of the invention is thereby intended.

### DETAILED DESCRIPTION OF THE INVENTION

The invention provides a protective cover for windows and glass doors, a method of installation of the protective cover over the window or door to be protected, and kits containing the protective cover and items needed to install the protective cover.

I. Protective Cover

The cover material of the invention is a flexible and resilient material selected to withstand hurricane force winds of at least 110 miles per hour (mph), and to absorb impacts of wind borne objects hitting the cover at speeds in excess of thirty two mph. A protective cover formed of rubber material, and particularly of a rubber pad material manufactured from recycled tires, has been found satisfactory. Satisfactory rubber pad materials are available from ECORE International of Lancaster, Pa., formerly DODGE-REGUPOL®, Inc., of Lancaster, Pa., under the names METAL MAT and Product 7620.

According to the manufacturer, the METAL MAT material has an essentially uniform composition and has the properties listed in Table 1.

TABLE 1
Metal Mat Properties

| Property | Test Method | Result | Units |
|---|---|---|---|
| Binder | ASTM D2000 | Co-polymer | N/A |
| Density | ASTM D297 | 0.93 min | g/cm³ |
| Tensile Strength - | ASTM D412-Die C | 350 | PSI |
| parallel to grain | | | |
| flow | | | |
| Tensile Strength - | ASTM D412-Die C | 400 | PSI |
| perpendicular to | | | |
| grain flow | | | |
| Elongation - parallel | ASTM D412-Die C | 125 | Percent |
| to grain flow | | | (%) |
| Elongation - | ASTM D412-Die C | 125 | Percent |
| perpendicular to | | | (%) |
| grain flow | | | |
| Durometer | ASTM D2240 | 60 ± 5 | Points |
| Hardness, A2 | | | |
| Tear Strength - | ASTM D624-Die C | 100 | PPI |
| parallel to grain | | | |
| flow | | | |
| Tear Strength - | ASTM D624-Die C | 110 | PPI |
| perpendicular to | | | |
| grain flow | | | |
| Flexibility | ASTM F147 | 0 | Factor |
| Thickness | | 2 mm nominal | mm |
| Coefficient of | ASTM D1894 | 1.25 | |
| Friction | | | |

According to the manufacturer, the Product 7620 material has an essentially uniform composition and has the properties listed in Table 2.

TABLE 2
All Rubber Product Data 7620

| Property | Test Method | Result | Units |
|---|---|---|---|
| Binder | ASTM D2000 | Co-polymer | N/A |
| Density | ASTM D297 | 1.03 min | g/cm³ |
| Tensile Strength - | ASTM D412-Die C | 750 min. | PSI |
| parallel to grain | | | |
| flow | | | |
| Tensile Strength - | ASTM D412-Die C | 575 min. | PSI |
| perpendicular to | | | |
| grain flow | | | |
| Elongation - parallel | ASTM D412-Die C | 140 min. | Percent |
| to grain flow | | | |
| Elongation - | ASTM D412-Die C | 125 min | Percent |
| perpendicular to | | | |
| grain flow | | | |
| Temperature Range | | −40 to 250 | ° F. |
| Durometer | ASTM D2240 | 70 min. | Points |
| Hardness, A2 | | | |
| Tear Strength - | ASTM D624-Die C | 145 min. | PPI |
| parallel to grain | | | |
| flow | | | |
| Tear Strength - | ASTM D62 Die C | 160 min. | PPI |
| perpendicular to | | | |
| grain flow | | | |
| Flexibility | ASTM F147 | 0 | Factor |
| Heat Aging | ASTM D573-Die C | ±25 max | Percent |
| change in Tensile | | | |
| Heat Aging | ASTM D573-Die C | ±25 max | Percent |
| change in | | | |
| Elongation | | | |
| Heat Aging | ASTM D573-Die C | ±10 max | Points |
| change in Hardness | | | |
| (Shore A) | | | |

This material has a shelf life of 5 years from date of manufacture when protected from environmental extremes.

The cover typically has a thickness ranging from about ¼ inch to 1 inch. ¼ inch Product 7620 has been found satisfactory, while METAL MAT material from about ½ inch thick to about ⅝ inch thick has been found satisfactory.

The cover may be of any suitable shape, but typically it is in the form of a rectangle. The length and width are suitable to cover a window or sliding glass door. Typically, the cover is at least two inches longer and wider than the window or door it is designed to cover and protect. Typically the height ranges from two feet to eight feet. Typically, the width ranges from two feet to four feet. Typical dimensions include two feet by two feet, two feet by three feet, four feet by four feet, four feet by seven feet, and four feet by eight feet. The protective cover can be made in standard dimensions of four feet by four feet and four feet by eight feet. Typical dimensions for covers for windows are four feet by four feet. Typical dimensions for covers for sliding doors are four feet by eight feet.

The dimensions and material for the cover are selected to form a cover that weighs as little as possible, while covering and protecting the window from winds of 110 mph or greater. Typically, a cover made from the above described material weighs up to sixty lbs, for a cover for a sliding door, and up to forty lbs for a cover for a window. Typically, covers for windows weigh from twenty lbs to forty lbs. However, covers for large windows may weigh up to sixty lbs. Typically, covers for sliding doors weigh between forty lbs and sixty lbs. Covers with the dimensions of four feet by eight feet and ½ inch thick, typically weigh about sixty lbs. Covers with the dimension of four feet by four feet and ½ inch thick, typically weigh about thirty lbs.

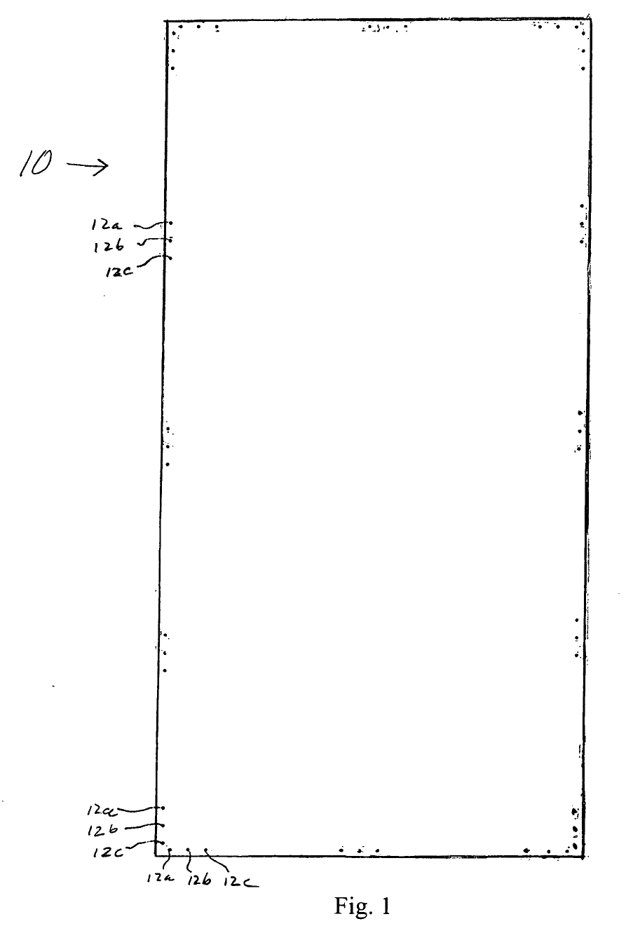

The cover will generally contain one or more preformed areas for attaching the cover to a building, a window frame around a window to be protected, a door frame around a door to be protected, or a buildout frame attached to the building around the window or door to be protected. These areas will usually include preformed holes through which the covering can be attached. Generally, when positioned over the window or door to be protected, the cover should be spaced from the window or door at least about two and one half inches and usually between about two and one half and about five inches. This allows room for the cover to stretch without hitting the window or door when subjected to high winds and particularly when hit by wind borne objects, while still not requiring a large, and probably unsightly, structure around the window or door which would be required if more spacing was needed. However, where windows or doors are flush mounted so are very close to the outside walls or window or door frames, a buildout frame will be required. FIG. 1 illustrates a cover 10 containing a plurality of sets of holes 12a, 12b, and 12c, with sets of holes in each corner of the cover and spaced along the perimeter of the cover.

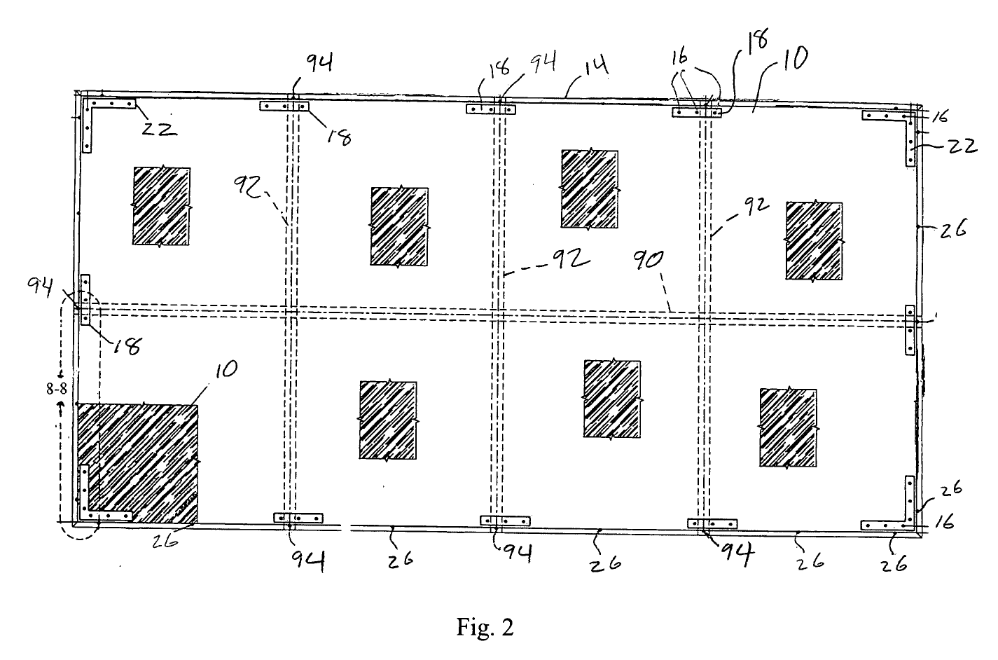

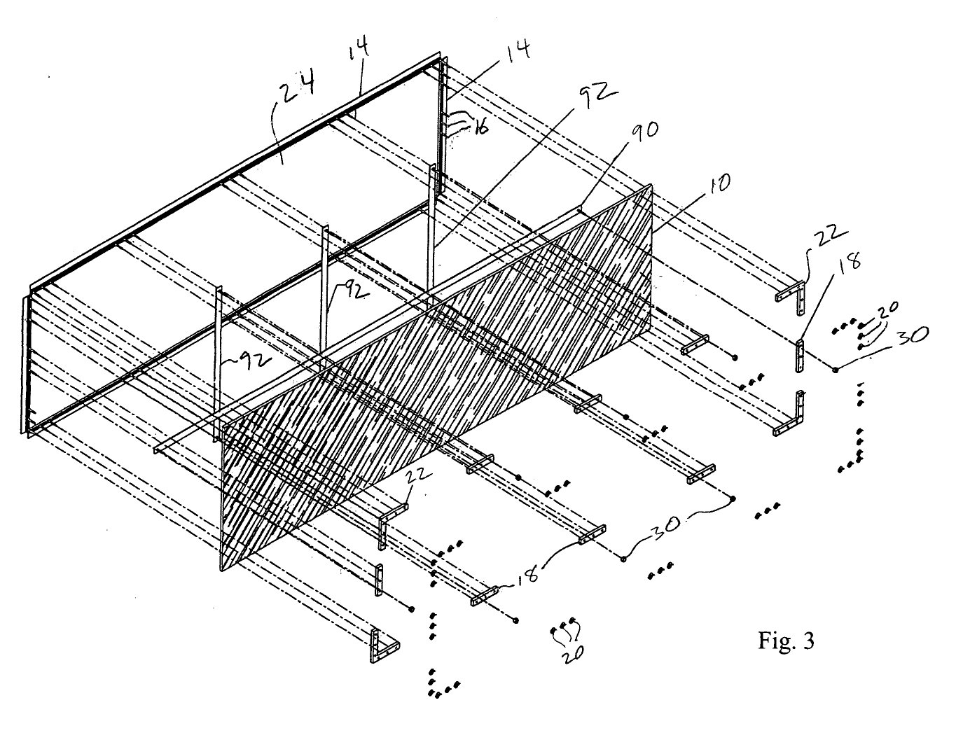

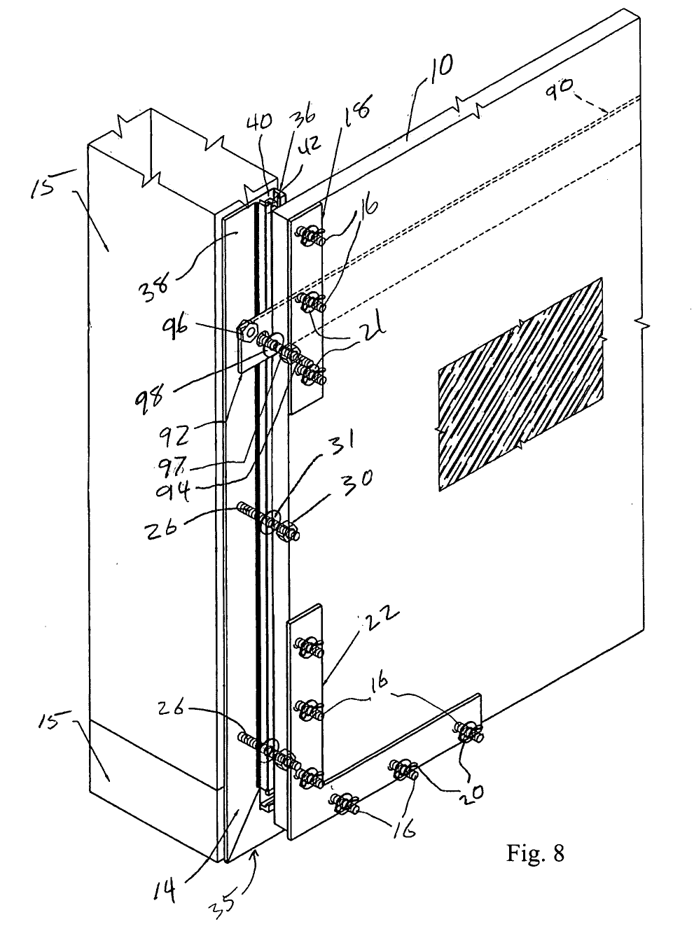

In the illustrated embodiments, see FIGS. 2, 3, and 8, a cover frame 14 is attached to a portion of a structure represented by wood or metal stud 15, FIG. 8, around the window or door, not shown, to be protected and may form a permanent installation. Cover 10 is removably attached to the cover frame 14. Cover frame 14 may have threaded studs 16 extending therefrom in the same pattern as the sets of holes 12a, 12b, and 12c through the cover so that cover 10 is positioned on the frame by the studs 16. With cover 10 positioned on cover frame 14, perimeter bars 18 are positioned on sets of studs 16, and wing nuts 20 are tightened onto studs 16 so as to sandwich cover 10 between cover frame 14 and perimeter bars 18. Washers 21, FIG. 8, can be positioned between wing nuts 20 and perimeter bars 18. This securely holds the perimeter of cover 10 to cover frame 14. The perimeter bars 18 can take the form of corner perimeter bars 22 at the corners of the frame. Frame 14 includes an open area 24, FIG. 3, for the window or door to be protected. When cover 10 is secured to cover frame 14, it covers open area 24.

Cover frame 14 is securely mounted to the structure by fasteners 26, such as bolts or screws, which pass through the frame 14 into the structure as shown in FIG. 8 at 15. Fasteners 26 may include inserts such as panelmates or anchors to provide threaded holes in the structure to receive the fasteners 26. Fasteners 26 are shown in FIGS. 2 and 8 as studs extending from the structure with nuts 30, FIG. 8, tightened on the studs to secure the cover frame to the structure. Washers 31 can be positioned between the nuts 30 and frame 14.

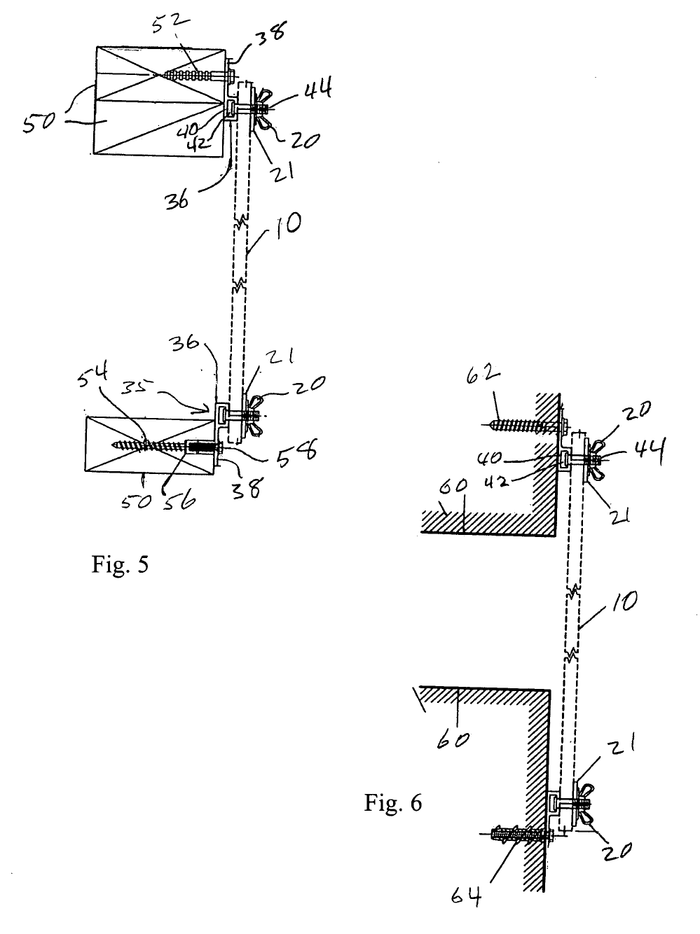

As illustrated in FIGS. 5-8, cover frame 14 may be formed by pieces of F track 35 cut to desired lengths and secured to the structure around the window or door openings. The pieces need not be secured together at their ends, but can form the cover frame by being secured to the structure in the desired shape, usually a rectangle. The F track 35 includes a track portion 36 and an integral flange portion 38 which extends from the track portion. Track portion 36 forms a groove 40 for receiving and slidably holding the head 42 of a bolt 44. Bolts 44 are slidably positioned in track grooves 40 with the threaded portion of the bolts extending outwardly from the track to form the studs 16.

The pieces of F track can be arranged so that an end of each piece is open so that bolts can be placed in the track when needed or removed when not needed, or the ends can be mitered together and an opening provided in one or more inside corners of the frame so that bolts can be inserted or removed. The F track is secured to the structure by fasteners 26 extending through the flange portion.

The mounting of F track to a structure having a recessed window framed in wood is shown in FIG. 5. The window, not shown, is framed by wooden two by fours 50. The F track pieces 35 can be secured to the wood window frame by various types of connectors. For example lag screws 52 can be screwed into the wood. Alternatively, a threaded sleeve 54 such as a female Elco construction panelmate can be screwed into the wood. The panelmate provides a threaded female portion 56 in the wood which can be used to receive a bolt 58. It could alternately receive a threaded stud to extend from the structure. FIG. 6 shows a similar installation for a masonry structure with bricks or concrete blocks 60 forming an opening for a window, not shown, recessed in the opening. Here, the track is secured to the bricks or blocks by using a female Elco construction panelmate 62 or an anchor such as a Buildex Tapcon anchor 64.

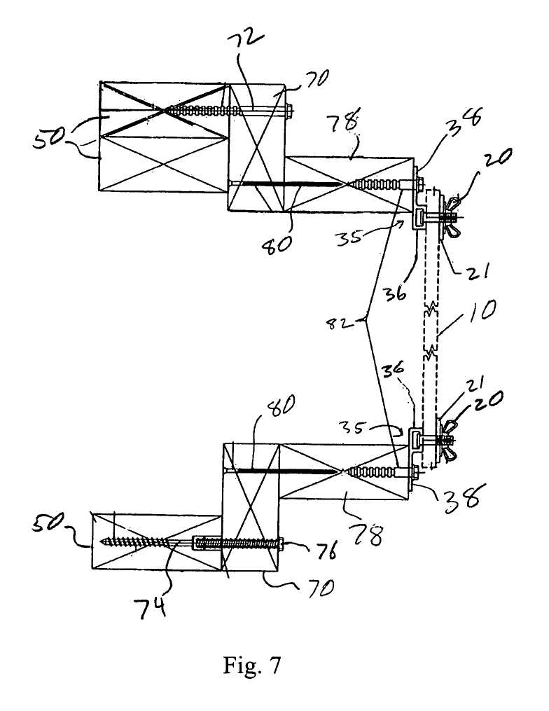

With recessed windows or doors, the cover frame, here formed of F track pieces, can be secured directly to the structure around the window or door. Because the window or door is recessed, the cover, when installed, will be at least about two and one half inches from the window or door surface. However, where the window or door is not recessed to provide the at least about two and one half inches between the installed cover and the surface of the window or door, the structure has to be built out around the window or door before attachment of the cover frame. Such a buildout is shown in FIG. 7. In this case, the window is again framed with wooden two by fours 50. Here however, rather that attaching the cover frame directly to the window frame, a buildout is provided by two by four 70 secured to the structure window frame such as by lag screws 72 or by a female Elco construction panelmate 74 with bolt 76 and a second two by four 78 secured to the first two by four 70 by screws or other fasteners 80. The cover frame, again shown as made up of pieces of F track 35, is attached to the edge of the second two by four 78 by lag screws 82. This illustrated arrangement of the buildout will add about five inches between the structure and window and the cover 10. Various other cover frame constructions, buildout constructions, and attachments to the structure can be used.

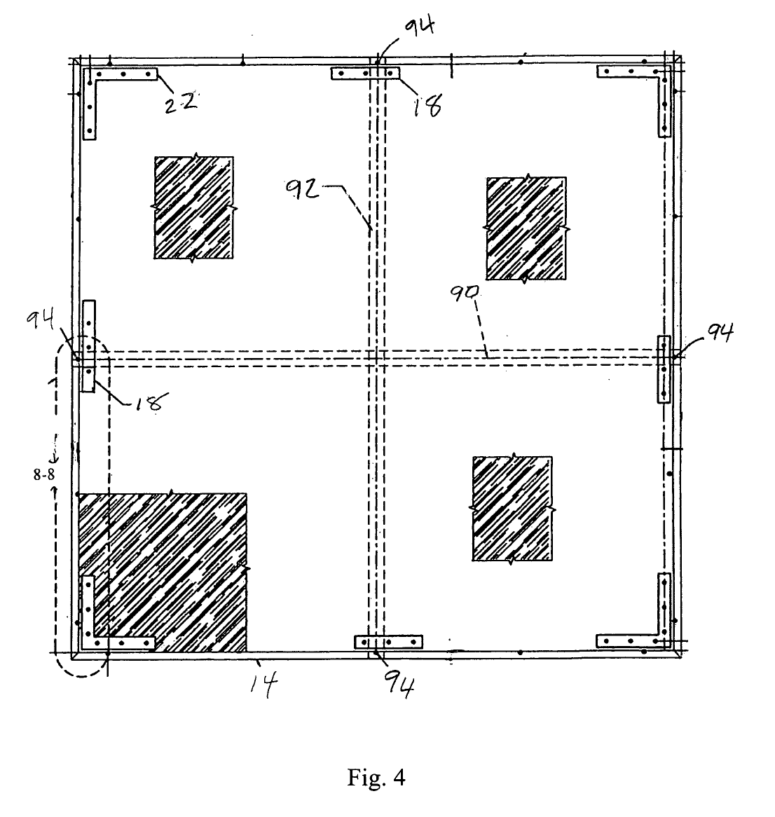

The cover frame and the cover can be made in various sizes to easily cover various sizes of windows and doors. The cover frame and cover shown in FIGS. 1-3 is shown as approximately a four foot by eight foot cover frame and cover. To illustrate a possible smaller cover frame and cover, FIG. 4 shows a cover frame and cover approximately four feet by four feet. The installation is the same as for the four foot by eight foot cover described.

It has been found that rubber mat materials, such as rubber mat material made from recycled tires, is strong enough to withstand hurricane winds and to absorb great impacts without tearing or puncturing. However, such materials stretch to an extent that they cannot normally protect a window or door without an extensive buildout. In other words, with normal size windows and doors which require cover dimensions of more than about two feet by two feet, the cover can stretch more than the maximum of about five inches that can be normally be provided between the cover and the window or door. Extensive, unsightly, and difficult buildouts would be needed. As far as the inventors know, there have not been any rubber material covers and covering systems that have been approved by the various counties, such as Dade County, Florida, for hurricane protection. A number of counties in the hurricane belt of the United States Southeast where hurricanes are common have ordinances that provide for certification of hurricane protection covers. Therefore, the mounting system of the present invention provides additional support for the cover between the cover and the window or door being protected to limit the stretch of the cover toward the window or door.

In the illustrated embodiment of the mounting system, straps are provided in conjunction with the cover frame to provide additional support for the cover. As shown in FIGS. 2, 3, 4, and 8, straps are provided to divide the open area within the cover frame into a plurality of smaller open areas. Referring to FIGS. 2 and 3, a horizontal strap 90 is secured horizontally across cover frame 14 to divide the open area of the cover into two smaller horizontal open areas. As indicated, the cover in FIGS. 2 and 3 represent a cover approximately four feet in height. Cover frame 14 therefore provides an open area 24 approximately four feet in height. Therefore, horizontal strap 90 divides the open area into two horizontal open area each approximately two feet in height. In FIGS. 2 and 3 which show a frame open area approximately eight feet in width, three vertical straps 92 are secured vertically across cover frame 14 to divide the open area of the cover frame into four smaller vertical open areas. With an approximately eight foot width, the three vertical straps divide the cover frame open area into four vertical open areas each approximately two feet wide. The combination of the horizontal and vertical straps divide the cover frame open area into smaller open areas approximately two feet by two feet. The straps are made of a material having limited stretch so the straps limit the stretch of the cover material toward the window or door when the material is against the straps. This has also been found to limit the stretch of the material in the smaller open areas between the straps to the extent necessary to protect the window or door from the cover material. Straps made of about one tenth inch thick galvanized steel have been found satisfactory. Such straps may be about three quarters of an inch wide. The number of straps necessary and the size of the smaller open areas will depend on the size of the frame opening and the cover material being used. It has been found that dividing the open area of the frame into smaller open areas of about two feet by two feet is sufficient to prevent window and door contact by the cover material when using a rubber mat material made from recycled tires and when the cover is secured greater than about two and one half inches from the window or door. Thus, referring to FIG. 4, one horizontal strap 90 and one vertical strap 92 are used to divide the approximately four foot by four foot cover frame opening into four two foot by two foot areas.

The straps should be securely mounted across the cover frame 14. Further, the straps should be removably mounted so that they can be removed when the cover is not needed to not interfere with the windows and doors when not covered. FIGS. 2-4 and 8 show the end portions of the straps secured to a projecting stud or bolt 94 projecting from a threaded female portion 56 of an Elco construction panelmate 54 such as shown in FIG. 5 for securing the cover frame 14 to the structure. Alternately, a bolt can extend through the emd of the strap and through the frame 14 to secure both to the structure. Referring to FIG. 8, stud 94 extends from the structure 15 through a receiving hole in the flange 38 of F track 35. A nut 96 is threaded onto the stud 94 and tightened against track flange 38 to secure the track in place and also acts as a spacer to the top of the F track portion 36 of the track. A hole in the end portion of horizontal strap 92 is place over the stud 94 and a nut 97 is tightened against washer 98 and strap 90 to sandwich them between nuts 97 and 96 to thereby secure the end of strap 90 to the frame 14 and the structure. Thus, as shown in FIG. 2, the fasteners 26 for the cover frame 14 at two foot intervals around the cover frame are extended to provide the strap fasteners 96 for the straps.

II. Kits for Protective Cover

A kit containing a presized protective cover and means for securing the cover to a building may be provided. Typically such a kit will contain a presized cover, components for constructing the cover track such as lengths of F track to provide a cover frame of dimensions to match the presized cover and components for securing the track pieces to the structure, bolts for placing in the F track to form the mounting studs for the perimeter of the cover, perimeter plates, wing nuts, the number of straps needed for the size of the presized cover and frame and nuts or bolts for securing the straps. The kit can also contain the parts and components necessary to assemble a buildout frame for attachment of the cover frame to the structure.

III. Use of the Protective Cover

When it is desired to cover the windows and doors, necessary straps are positioned over and secured to a prepositioned cover frame. The protective cover may then be placed on and secured to the cover frame over the window or door needing protection. With a cover frame having slidable bolts in a track providing the securement of the cover around the perimeter of the cover, bolts are placed in the track and moved to appropriate locations along the top, bottom, and sides of the cover frame. The bolts can be held in approximate position in the vertical sides of the cover frame by tape during installation of the cover. The cover may be attached to the cover frame by positioning the bolts in the top frame so as to extend through the cover holes. If desired, these can be held in the cover by the perimeter plate and wing nuts. Since the cover is flexible, it is then maneuvered along the side of the frame and the bolts are positioned along the track to extend through the side holes in the cover. Then the bottom bolts can be positioned to extend through the bottom holes in the cover. The perimeter bars are then all secured in place by the wingnuts.

Optionally, for large windows or doors, more than one cover may be used to cover the window or door. One cover may be connected to another cover by overlapping the covers on the cover frame.

The present invention will be further understood by reference to the following non-limiting examples.

### EXAMPLE

A cover four feet wide and four feet long with ½ inch thickness was tested using two tests. The cover material was a rubber material sold under the tradename METAL MAT by DODGE-REGUPOL®, Inc., Lancaster, Pa. The first test was a missile impact test. The cover was attached to a window frame using multiple flat bars of metal with 4 holes. The metal bars were placed on each side of the square material, evenly spaced, with ten inches between each metal bar. This arrangement secured the cover to each side of the window frame.

A two by four was shot at 110 mph from a distance fourteen feet from the cover. The test was repeated four times. Each time, the two by four bounced off of the cover. The cover did not break under the force.

In contrast, when the two by four was shot at 110 mph from a distance of fourteen feet from a cover formed of ½ inch thick plywood, the two by four broke the plywood.

The second test was the Standard Test Method for Structural Performance of Exterior Windows, Doors, Skylights and Curtain Walls by Uniform Static Air Pressure Difference (ASTM E 330). This is a standard test to assess the structural performance of exterior windows, doors, skylights, and curtain walls under uniform static air pressure differences (i.e. different wind loads), using a test chamber. In this test, the cover material was again a rubber material sold under the tradename METAL MAT by DODGE-REGUPOL®, Inc., Lancaster, Pa. The cover was subjected to different forces under both positive and negative loads and the deflection of the material was measured. The test conditions and corresponding measured deflection when the material was subjected to a positive load are provided in Table 3.

TABLE 3
Test Conditions and Deflection of Cover Material
under Positive Load

| Test Conditions (pounds per | Deflection of Cover Material |
|---|---|
| square foot) (psf) | (inches) |
| 50.0 | 1.125 |
| 60.0 | 2.000 |
| 70.0 | 2.250 |
| 80.0 | 2.500 |
| 90.0 | 2.625 |
| 100.0 | 2.875 |
| 120.0 | 3.125 |
| 140.0 | 3.375 |
| 150.0 | 3.625 |

The test conditions and corresponding measured deflection when the material was subjected to a negative load are provided Table 4.

TABLE 4
Test Conditions and Deflection of Cover Material
under Negative Load

| Test Conditions | |
|---|---|
| (pounds per square foot) | Deflection of Cover Material |
| (psf) | (inches) |
| 50.0 | 1.625 |
| 60.0 | 2.125 |
| 70.0 | 2.375 |
| 80.0 | 2.500 |
| 90.0 | 2.625 |
| 100.0 | 2.750 |
| 120.0 | 2.937 |
| 140.0 | 3.125 |
| 150.0 | 3.375 |

The material performed very well under high loads, which simulate the air pressure that pushes and pulls on a cover during a hurricane. Winds at speeds of 220 mph typically exert loads equivalent to 150 psf. At 150 psf, the material did not break, and elongated by only 3.375-3.625 inches. According to current Miami-Dade County codes, such materials are acceptable for use as hurricane covers.

Additional testing has been done with rubber mat material of ¼ inch thickness identified as Product 7620 from ECORE International, formerly DODGE-REGUPOL®, Inc., Lancaster, Pa. This material, when mounted as described with the straps, has passed all tests required by Dade County, Florida for certification as hurricane protection material when used in conjunction with the mounting system as described. Again, the material successfully stopped the two by fours shot at it without any breaking, tearing, or puncturing of the material, leaving the material ready for additional uses, and prevented breakage of the protected windows.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

1. A system for storm protection of windows and doors in a structure, comprising:
a frame for surrounding the window or door to be protected and adapted to be secured to the structure so as to surround the window or door to be protected, said frame including opposite vertical sides, a horizontal top, and a horizontal bottom forming an open area within the frame;
studs extending from the frame at spaced intervals around the window or door to be protected;
at least one horizontal cross strap extending substantially horizontally between the opposite sides of the frame and across the open area to divide the open area into a plurality of horizontal open areas of maximum predetermined size;
at least one vertical cross strap extending substantially vertically between the top and bottom of the frame and across the open area to divide the open area into a plurality of vertical open areas of maximum predetermined size;
a protective cover sized to fit over the frame and having receiving holes therethrough to receive the studs extending from the frame, said cover made of a resilient material;
a plurality of perimeter bars having a plurality of receiving holes therethrough to receive a selected plurality of adjacent studs to space the perimeter bars at intervals around the window or door to be protected with the cover sandwiched between the perimeter bars and the frame and said horizontal and vertical cross straps being positioned between the cover and the open area of the frame; and
fasteners secured to the studs passing through the perimeter bars to secure the perimeter bars and the cover to the frame.

2. A system for storm protection of windows and doors in a structure, according to claim 1, wherein the plurality of perimeter bars includes four corner bars.

3. A system for storm protection of windows and doors in a structure, according to claim 1, wherein the cover material can stretch under force, and wherein the vertical and horizontal straps limit the stretch of the cover material.

4. A system for storm protection of windows and doors in a structure, according to claim 3, wherein the maximum predetermined size of the vertical and horizontal open areas are determined based upon stretch characteristics of the cover.

5. A system for storm protection of windows and doors in a structure, according to claim 4, wherein the maximum predetermined size of the vertical and horizontal open areas are two feet by two feet.

6. A system for storm protection of windows and doors in a structure, according to claim 5, wherein the resilient material is a rubber material manufactured from recycled tires.

7. A system for storm protection of windows and doors in a structure, according to claim 1, wherein the resilient material is a rubber material manufactured from recycled tires.

8. A system for storm protection of windows and doors in a structure, according to claim 7, wherein the cover weighs less than 60 lbs, wherein the material forming the cover has a tensile strength of at least 350 PSI, a density of at least 0.93 g/cm³, and wherein the cover is sized to fit over a window or door.

9. A system for storm protection of windows and doors in a structure, according to claim 8, wherein the material has a thickness ranging from ¼ inch to 1 inch.

10. A system for storm protection of windows and doors in a structure, comprising:
a protective cover sized to fit over the window or door to be protected, said cover made of a resilient material;
means for attaching the cover to the structure so that the cover extends over the window or door to be protected;
means between the cover and the window or door to be protected to limit stretching of the cover.

11. A system for storm protection of windows and doors in a structure, according to claim 10, wherein the resilient material is a rubber material manufactured from recycled tires.

12. A system for storm protection of windows and doors in a structure, according to claim 10, wherein the means between the cover and the window or door to be protected to limit stretching of the cover is at least one cross strap extending across the window or door to be protected.

13. A system for storm protection of windows and doors in a structure, according to claim 12, wherein the means between the cover and the window or door to be protected to limit stretching of the cover is at least one cross strap extending horizontally across the window or door to be protected, and at least one cross strap extending vertically across the window or door to be protected.

14. A method for protecting a window or door during a storm comprising attaching to the outside of the window frame or door frame a cover formed of a resilient material; and supporting the cover between the cover and the window or door to be protected to limit stretching of the cover.

15. A method for protecting a window or door during a storm according to claim 14, wherein the step of attaching to the outside of the window frame or door frame a cover formed of a resilient material is the step of attaching to the outside of the window frame or door frame a cover formed of a resilient rubber material made from recycled tires.
